(19) United States
(12) Patent Application Publication
(10) Pub. No.: US 2007/0043695 A1
(43) Pub. Date: Feb. 22, 2007

(54) Action consolidation using hash table

(76) Inventors: Ballard C. Bare, Auburn, CA (US); Shaun K. Wakumoto, Roseville, CA (US); Daniel E. Ford, Granite Bay, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/205,358

(22) Filed: Aug. 16, 2005

(51) Int. Cl. G06F 17/30

(52) U.S. Cl. 707/2

(57) ABSTRACT

One embodiment relates to a method of action consolidation so as to avoid duplicative actions. A hash function is applied to a unique value relating to event-related data so as to create a hash key, and the hash key is used in determining whether duplicate data is already present in a hash table. A new hash entry with the event-related data is added to the hash table if duplicate data is absent from the hash table. Other embodiments are also disclosed.

### BACKGROUND OF THE INVENTION

1. Field of the Invention

The present invention relates generally to communication networks and other systems.

2. Description of the Background Art

Unnecessary duplicate actions result in inefficiency in communication networks and other systems. For example, a packet may be received by a network router that queries the router about multicast addresses joined on other interfaces of the router. Each interface of the router may join various multicast addresses independent of the other interfaces, such that more than one interface may join the same multicast address. In this case, however, the device sending the query is requesting all the different multicast addresses joined and does not care about which interface or how many interfaces have joined each multicast address. Hence, unnecessary processing and undesirable overhead occurs if the router returns redundant or duplicate multicast addresses.

One prior method is to not filter the duplicate trigger events. This is advantageously simple, but it creates unnecessary processing and undesirable overhead.

Another prior method is to filter out redundant trigger events using a list of previous trigger events. This technique keeps track of the previous trigger events taken and scan the list of these previous trigger events each time before acting upon a new trigger event. If the same (redundant) trigger event is found in the list, then no action need be taken for the new trigger event. While this technique works to prevent duplicate actions, it is disadvantageously slow and scales poorly.

### SUMMARY

One embodiment relates to a method of action consolidation so as to avoid duplicative actions. A hash function is applied to a unique value relating to event-related data so as to create a hash key, and the hash key is used in determining whether duplicate data is already present in a hash table. A new hash entry with the event-related data is added to the hash table if duplicate data is absent from the hash table.

Another embodiment relates to an apparatus for action consolidation. The apparatus includes at least a processor, a data structure, and a hash table having a hash function associated therewith. The hash function is applied to a unique value relating to event-related data so as to create a hash key which is used in determining whether duplicate data is already present in the hash table. Processor-executable code is configured to add a new hash entry with the event-related data to the hash table if duplicate data is absent from the hash table.

Another embodiment relates to a system of action consolidation so as to avoid duplicative actions. The system includes at least means for applying a hash function to a unique value relating to event-related data so as to create a hash key, means for using the hash key in determining whether duplicate data is already present in a hash table, and means for adding a new hash entry with the event-related data to the hash table if duplicate data is absent from the hash table.

Other embodiments are also disclosed.

### BRIEF DESCRIPTION OF THE DRAWINGS

FIG. 1 is a flow chart depicting a method of action consolidation using a hash table and data structure in accordance with an embodiment of the invention.

FIG. 2 is a schematic diagram illustrating a hash table and an associated linked list in accordance with an embodiment of the invention.

FIG. 3 is a flow chart depicting a procedure for putting a trigger event into a hash table and linked list using a non-duplicative technique in accordance with an embodiment of the invention.

FIG. 4 is a flow chart depicting a procedure for using the linked list to extract a consolidated list of trigger events in accordance with an embodiment of the invention.

### DETAILED DESCRIPTION

The present disclosure provides an advantageous technique to consolidate actions taken when events or data information exists that could unnecessarily or undesirably result in duplicate actions. In the general case, state machine implementations take specific actions based on the current state and event. However, in some environments, duplicate information or events may needlessly trigger the same action multiple times. The apparatus and methods disclosed herein may be advantageously utilized to prevent such unnecessary or unwanted duplicate actions in a scalable manner. In other words, the present disclosure provides an efficient technique for the filtering out of unneeded duplicate events and or data so that a state machine will not take duplicate actions for each duplicated event or data.

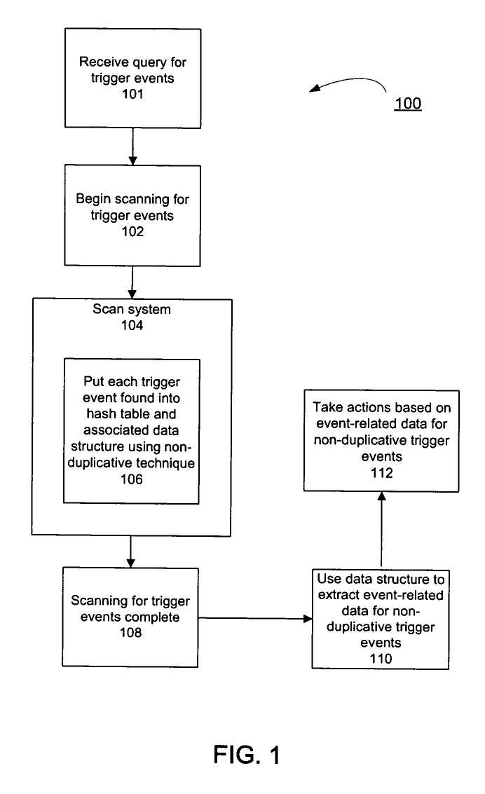

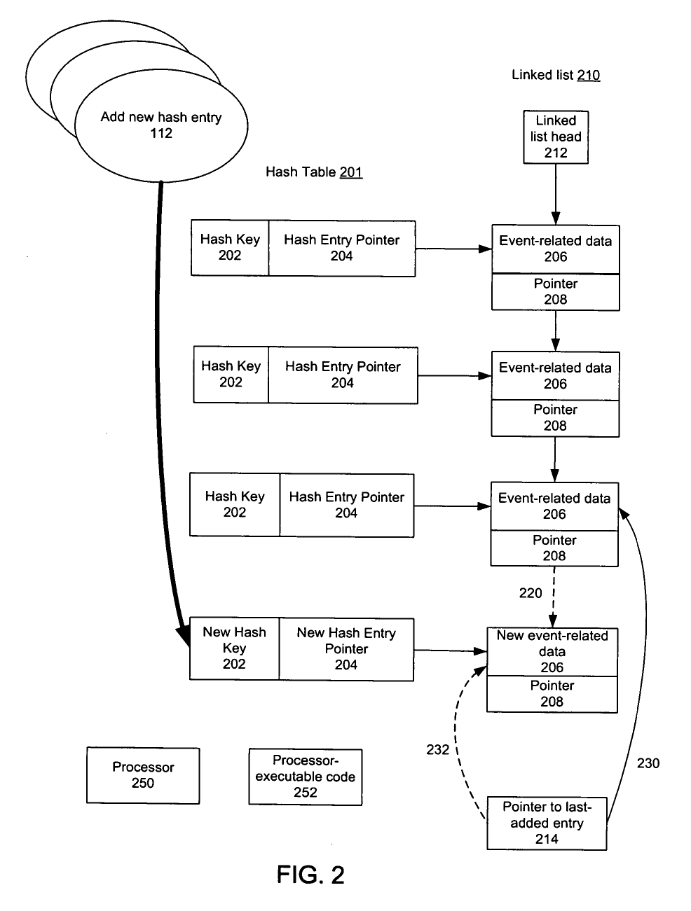

FIG. 1 is a flow chart depicting a method 100 of action consolidation using a hash table and an associated data structure in accordance with an embodiment of the invention. In one embodiment, the data structure comprises a linked list. In another embodiment, the data structure may comprise a bit map table or other data structure. For example, a hash table 201 and an associated linked list 210 is schematically depicted in FIG. 2.

The method 100 may be initiated, for example, when the receiving device receives 101 a query requesting event-related data which pertains to particular action-triggering events (trigger events). Upon receiving 101 the query, the receiving device may begin 102 scanning for the trigger events.

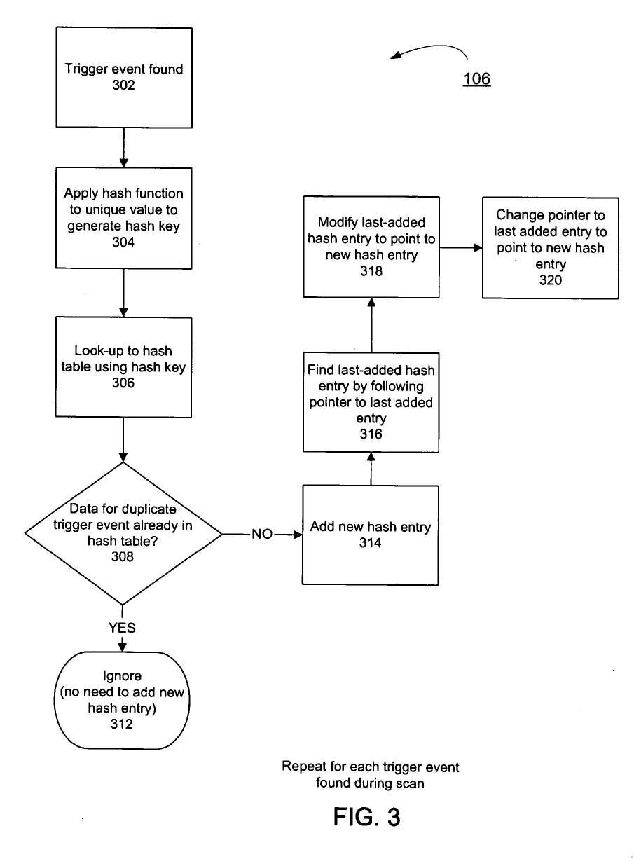

During the scan 104 of the system, event-related data for each trigger event found is put 106 into a hash table and an associated data structure using a non-duplicative technique. For example, one procedure for putting 106 the event-related data into a hash table 201 and an associated linked list 210 in an efficient way that avoids duplicate entries is described in detail below in relation to FIG. 3. Note that other embodiments of this invention may build the non-duplicative hash table and link list as new events occur rather than via a scanning mechanism searching for event-related data.

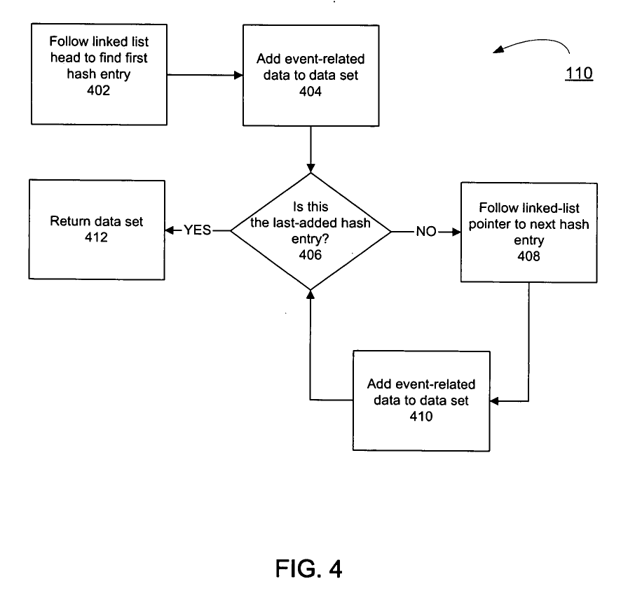

Once the scanning for trigger events is complete 108, the receiving device may use 110 the data structure to efficiently extract the non-duplicative event data from the hash table. For example, one procedure for using 106 a linked list 210 to extract the non-duplicate event data is described below in relation to FIG. 4.

Hence, only non-duplicate event data are returned 112 to the querying device. This may advantageously save bandwidth and processing. Actions may then be taken 114 by the querying device based on the non-duplicative event data so as to avoid redundant actions.

FIG. 2 is a schematic diagram illustrating a hash table 201 and an associated linked list 210 in accordance with an embodiment of the invention. The entries of the hash table 201 are indexed according to their hash keys 202. Each hash entry includes a hash entry pointer 204 pointing to the event-related data 206 for that entry. Each hash entry also includes a linked-list pointer 208.

The linked list 210 begins at a linked list head 212 which points to a first event-related data 206. Each linked-list pointer 208 points to a next event-related data 206 so as to form the linked list 210. The linked list 210 also includes a pointer 214 to last-added entry. The pointer 214 to last-added entry points to a most recently added hash entry having event-related data 206 therein.

Processor 250 and processor-executable code 252 are configured to operate on the hash table 201 and linked list 210 as described below in relation to FIGS. 3 and 4.

FIG. 3 is a flow chart depicting a procedure for putting 106 a trigger event into a hash table 201 and linked list 210 using a non-duplicative technique in accordance with an embodiment of the invention. The method of FIG. 3 is repeated for each trigger event found during the scan 104.

When a trigger event is found 302, the receiving device may be configured to apply 304 a hash function to a unique value relating to the trigger event so as to generate a hash key 202. Various hash functions may be used depending upon the characteristics of the trigger events and the unique values associated therewith. The hash key 202 is used to perform a look-up 306 to the hash table. The look-up determines 308 whether the hash key 202 is already in the hash table 201.

If the look-up indicates that the event-related data 206 for this particular trigger event is already in the hash table 201, then this particular trigger event may be ignored 312. In other words, there is no need to add 314 a new hash entry for this trigger event as such an entry would be duplicative. On the other hand, if the look-up indicates that the event-related data 206 for this trigger event is not in the hash table 201, then a new hash entry is added 314 as it is not duplicative of data already in the hash table 201.

Regarding the linked list 210, when the new hash entry is added, the pointer 214 to the last-added entry is used to find 316 the last-added hash entry. The last-added hash entry is modified 318 so that its linked-list pointer 208 now points 220 to the new hash entry. In addition, the pointer 214 to the last added entry is changed 320 from pointing 230 to the last-added entry to pointing 232 to the new hash entry (which becomes the new last-added entry).

FIG. 4 is a flow chart depicting a method of using 110 a linked list 210 to extract a consolidated list of trigger events in accordance with an embodiment of the invention. While the embodiment shown in FIG. 4 utilizes a linked list, other embodiments may similarly utilize other data structures, such as, for example, a bit map table.

The method of FIG. 4 starts at the linked list head 212 and follows 402 it to find the first hash entry with event-related data. This event-related data is added 404 to a data set.

A determination 406 is then made as to whether the hash entry just retrieved is the last-added hash entry. This determination 406 may be made, for example, by comparing the address of the hash entry just retrieved with the address in the pointer 214 to the last added entry. If the addresses are different, then there are more hash entries to be retrieved. In that case, the linked-list pointer 208 associated with the hash entry just retrieved is followed 408 to find the next hash entry in the linked list 210. The event-related data for this hash entry is then added 410 to the data set.

The process 110 then loops back to again determine 406 whether the hash entry just retrieved is the last-added hash entry. The process 110 thus continues through the linked list 210 until the last-added hash entry has been retrieved and processed. Once it is determined 406 that the last-added hash entry has been retrieved and processed, then the desired hash entries have all been extracted. In that case, the data set is complete and may be returned 412 in response to the original query for trigger events (i.e. in response to 101 in FIG. 1).

Example of Multicast Joins

In one particular embodiment relating to an IGMP (Internet Group Management Protocol) proxy, the receiving device may comprise a router, and the trigger events may comprise multicast joins by the interfaces of the router. In this example embodiment, the querying device is requesting all the data set including all the different multicast addresses joined and does not care about which interface or how many interfaces have joined each multicast address. In this example, upon receiving 101 the query, the router may begin 102 scanning its interfaces for multicast joins. During the scan 104 of the interfaces of the router, each multicast address found is put 106 into a hash table and linked list (or similar data structure) using a non-duplicative technique. Here, the multicast address may be used as the input into the hash function so as to generate the hash key which indexes into the hash table. Various hash functions may be used on the multicast addresses as known to one of ordinary skill in the pertinent art. Upon completion 108 of the scan 104 of all the interfaces for multicast joins, including putting 106 the multicast addresses found in the hash table and linked list, then the linked list may be utilized 110 to efficiently extract the non-duplicative multicast addresses. Hence, only non-duplicate multicast addresses are returned 112 to the querying device. This may advantageously save bandwidth and processing. Actions may then be taken 114 by the querying device based on the non-duplicative multicast addresses so as to avoid redundant actions. In this example, once the non-duplicative data has been extracted, proxy joins are issued out the proxy interface, and the hash table is cleared to prepare for the next query on the proxy interface.

### CONCLUSION

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A method of action consolidation so as to avoid duplicative actions, the method comprising:
applying a hash function to a unique value relating to event-related data so as to create a hash key;
using the hash key in determining whether duplicate data is already present in a hash table; and
adding a new hash entry with the event-related data to the hash table if duplicate data is absent from the hash table.

2. The method of claim 1, further comprising:
modifying a data structure to include the new hash entry if the new hash entry is added to the hash table.

3. The method of claim 2, further comprising:
using the data structure to extract a data set of non-duplicate event-related data from the hash table.

4. The method of claim 2, wherein the data structure comprises a bit map table.

5. The method of claim 2, wherein the data structure comprises a linked list.

6. The method of claim 5, further comprising:
linking the new hash entry to a last-added hash entry;
modifying the last-added hash entry to point to the new hash entry; and
changing a pointer to last-added entry to point to the new hash entry.

7. The method of claim 5, whereby the linked list starts at a hash entry pointed to by a linked list head and ends at the last-added hash entry.

8. The method of claim 5, further comprising:
following the linked list to extract a data set of non-duplicate event-related data from the hash table.

9. The method of claim 1, wherein the event-related data comprises a multicast address joined by at least one interface of a router, and wherein the unique value comprises the multicast address.

10. An apparatus for action consolidation, the apparatus comprising:
a processor;
a data structure;
a hash table having a hash function associated therewith which is applied to a unique value relating to event-related data so as to create a hash key which is used in determining whether duplicate data is already present in the hash table; and
processor-executable code configured to add a new hash entry with the event-related data to the hash table if duplicate data is absent from the hash table.

11. The apparatus of claim 10, further comprising:
processor-executable code configured to modify the data structure to include the new hash entry if the new hash entry is added to the hash table.

12. The apparatus of claim 11, further comprising:
processor-executable code configured to utilize the data structure to extract a data set of non-duplicate event-related data from the hash table.

13. The apparatus of claim 11, wherein the data structure comprises a bit map table.

14. The apparatus of claim 11, wherein the data structure comprises a linked list.

15. The apparatus of claim 14, further comprising:
processor-executable code configured to link the new hash entry to a last-added hash entry, to modify the last-added hash entry to point to the new hash entry, and to change a pointer to last-added entry to point to the new hash entry.

16. The apparatus of claim 14, wherein the linked list starts at a hash entry pointed to by a linked list head and ends at the last-added hash entry.

17. The apparatus of claim 14, further comprising:
processor-executable code configured to follow the linked list to extract a data set of non-duplicate event-related data from the hash table.

18. The apparatus of claim 10, wherein the event-related data comprises a multicast address joined by at least one interface of a router, and wherein the unique value comprises the multicast address.

19. A system of action consolidation so as to avoid duplicative actions, the system comprising:
means for applying a hash function to a unique value relating to event-related data so as to create a hash key;
means for using the hash key in determining whether duplicate data is already present in a hash table; and
means for adding a new hash entry with the event-related data to the hash table if duplicate data is absent from the hash table.

20. The system of claim 19, further comprising:
means for modifying a data structure to include the new hash entry if the new hash entry is added to the hash table.

21. The system of claim 20, further comprising:
means for using the data structure to extract a data set of non-duplicate event-related data from the hash table.
